(19) United States
(12) Patent Application Publication
(10) Pub. No.: US 2024/0119279 A1
(43) Pub. Date: Apr. 11, 2024

(54) CONTRASTIVE EMBEDDING OF STRUCTURED SPACE FOR BAYESIAN OPTIMIZATION

(71) Applicant: Spotify AB, Stockholm (SE)

(72) Inventors: Zhenwen Dai, London (GB); Ciarán M. Gilligan-Lee, London (GB); Josh C. Tingey, Manchester (GB)

(73) Assignee: Spotify AB, Stockholm (SE)

(21) Appl. No.: 18/056,101

(22) Filed: Nov. 16, 2022

Related U.S. Application Data
(60) Provisional application No. 63/377,284, filed on Sep. 27, 2022.

(51) Int. Cl. G06N 3/08

(52) U.S. Cl. CPC G06N 3/08

(57) ABSTRACT

Contrastive learning is used to learn an alternative embedding. A subtree replacement strategy generates structurally similar pairs of samples from an input space for use in contrastive learning. The resulting embedding captures more of the structural proximity relationships of the input space and improves Bayesian optimization performance when applied to tasks such as fitting and optimization.

### CROSS REFERENCE TO RELATED APPLICATIONS

This application claims priority to, and the benefit of, U.S. Provisional Patent Application Ser. No. 63/377,284, filed Sep. 27, 2022, which is hereby incorporated by reference in its entirety.

### TECHNICAL FIELD

Example aspects described herein relate generally to search optimization, and more particularly to using contrastive learning to learn an alternative embedding for Bayesian optimization.

### BACKGROUND

There are a family of valuable search problems involving structured data, such as arithmetic expressions, molecular structures, source code, and neural architectures. Commonly, these structured search spaces contain both a high number of effective dimensions and a vast number of possible candidate datapoints. It is typically desirable to use a sample efficient search technique such as Bayesian optimization (BO) in such settings. However, most BO methods are used for a continuous, low-dimensional space making their applications challenging. Previous work has attempted to address this problem using probabilistic generative models, such as Variational Autoencoders (VAEs), to map a structured input space to a latent embedding space that is both low-dimensional and continuous. BO can then be performed within the latent embedding space to optimize the search objective. This is usually referred to as Latent Space Optimization (LSO) and has been successfully applied in a range of scenarios, including chemical design, neural architecture search, the automatic statistician task, and autonomous robotics.

However, by design, the generative nature of VAEs does not necessarily produce an optimal embedding within which to perform optimization. Indeed, generative models must explicitly model the complete variance of the data. While this generally leads to a smooth local structure, it ignores the fact that a large amount of data variance may be unimportant to the objective, and more distant structural relationships may be helpful. One advantage of structured input spaces is that there typically exists prior knowledge of how structurally similar datapoints are, and so a method that explicitly uses these distance relations, unlike a VAE, could improve the quality of the embedding for use in optimization.

### SUMMARY

The example embodiments described herein meet the above-identified needs by providing methods, systems and computer program products for performing contrastive embedding of a structured space.

Generally, contrastive learning is used to learn an alternative embedding. A subtree replacement strategy generates structurally similar pairs of samples from an input space for use in contrastive learning. The resulting embedding captures more of the structural proximity relationships of the input space and improves Bayesian optimization performance when applied to tasks such as fitting and optimization.

In one aspect, a method for performing contrastive embedding of a structured space involves receiving an input sample set of data (x) corresponding to an input space (χ); obtaining a set of rules (R) defining similarities in an embedding of the sample set of data (x); training a deep neural network using a contrastive learning algorithm to learn a representation of the sample set of data (x) by modelling a plurality of points in the sample set of data based on the set of rules; supplying the representation of the sample set of data (x) to a search system to apply a search algorithm on the representation of the sample set of data(x).

In some embodiments, the method further involves selecting from the representation of the sample set of data (x) a datapoint having a score that is higher than a score associated with other datapoints in the representation of the sample set of data (x), using a search algorithm.

In yet other embodiments, the method further involves obtaining a subtree replacement lookup dictionary (L); generating, for every sample of the input sample set of data (x), a tree representation (xₜᵣₑₑ), thereby creating a set of tree representations; for each tree in the set of tree representations, generating a list of trees that are similar, thereby generating a list of similar trees; generating a set of similar trees based on the list of similar trees; applying the contrastive learning algorithm to the set of similar trees to obtain a deep neural network; and mapping, using the deep neural network, each tree in the list of similar trees to a corresponding vector representation having a predetermined length. In some embodiments, generating the list of similar trees is performed by: receiving an anchor sequence (x), a number of replacements (1, 2, . . . , N), a maximum subtree height (H) and a subtree replacement lookup dictionary (L); parsing the anchor sequence (x) into a tree representation (xₜᵣₑₑ); randomly selecting a random choice (n) from the number of replacements (1, 2, . . . , N); and from 1 to the random choice (n): randomly selecting a subtree (t) in the tree representation (xₜᵣₑₑ) having a height less than the maximum subtree height (H), selecting a replacement subtree (r) from the subtree replacement lookup dictionary (L), and replacing the subtree (t) from the tree representation (xₜᵣₑₑ) with the replacement subtree (r) to generate an updated tree representation (updated xₜᵣₑₑ).

In some embodiments, the search algorithm is a Bayesian optimization search algorithm.

In some embodiments, a system for performing contrastive embedding of a structured space involves a rules database configured to store rules defining similarities in embeddings of the sample sets of data; an input sample receiver configured to receive an input sample set of data (x) corresponding to an input space (χ); a machine learning kernel configured to: obtain, from the rules database, a set of rules (R) defining similarities in an embedding of the sample set of data (x), and train a deep neural network using a contrastive learning algorithm to learn a representation of the sample set of data (x) by modelling a plurality of points in the sample set of data based on the set of rules; and a network access device configured to supply the representation of the sample set of data (x) to a search system to enable the search system to apply a search algorithm on the representation of the sample set of data (x).

In some embodiments, the system involves a search system configured to select from the representation of the sample set of data (x) a datapoint having a score that is higher than a score associated with other datapoints in the representation of the sample set of data (x), using the search algorithm.

In some embodiments, the system further involves a subtree replacement lookup dictionary database configured to store one or more subtree replacement lookup dictionaries; a tree representation generator configured to: obtain a subtree replacement lookup dictionary (L) from the subtree replacement lookup dictionary database and generate, for every sample of the input sample set of data (x), a tree representation (xₜᵣₑₑ), thereby creating a set of tree representations, for each tree in the set of tree representations, generate a list of trees that are similar, thereby generating a list of similar trees, and generate a set of similar trees based on the list of similar trees; and the machine learning kernel is configured to apply the contrastive learning algorithm to the set of similar trees to obtain a deep neural network; and a mapper configured to map, using the deep neural network, each tree in the list of similar trees to a corresponding vector representation having a predetermined length.

In some embodiments, the input data set receiver 104 further configured to receive an anchor sequence (x), a number of replacements (1, 2, . . . , N), a maximum subtree height (H) and a subtree replacement lookup dictionary (L); and the system further involves a parser configured to parse the anchor sequence (x) into a tree representation (xₜᵣₑₑ); a random choice selector operable to randomly select a random choice (n) from the number of replacements (1, 2, . . . , N); and a tree representation generator 110 configured to: from 1 to the random choice (n): randomly select a subtree (t) in the tree representation (xₜᵣₑₑ) having a height less than the maximum subtree height (H), select a replacement subtree (r) from the subtree replacement lookup dictionary (L), and replace the subtree (t) from the tree representation (xₜᵣₑₑ) with the replacement subtree (r) to generate an updated tree representation (xₜᵣₑₑ (updated)).

In some embodiments, the search algorithm is a Bayesian optimization search algorithm.

In yet another embodiment, there is provided a non-transitory computer-readable medium having stored thereon one or more sequences of instructions for causing one or more processors to perform: receiving an input sample set of data (x) corresponding to an input space (χ); obtaining a set of rules (R) defining similarities in an embedding of the sample set of data (x); training a deep neural network using a contrastive learning algorithm to learn a representation of the sample set of data (x) by modelling a plurality of points in the sample set of data based on the set of rules; and supplying the representation of the sample set of data (x) to a search system to apply a search algorithm on the representation of the sample set of data(x).

In some embodiments, the non-transitory computer-readable medium further has stored thereon a sequence of instructions for causing the one or more processors to perform: selecting from the representation of the sample set of data (x) a datapoint having a score that is higher than a score associated with other datapoints in the representation of the sample set of data (x), using a search algorithm.

In some embodiments, the non-transitory computer-readable medium further has stored thereon a sequence of instructions for causing the one or more processors to perform: obtaining a subtree replacement lookup dictionary (L); generating, for every sample of the input sample set of data (x), a tree representation (xₜᵣₑₑ), thereby creating a set of tree representations; for each tree in the set of tree representations, generating a list of trees that are similar, thereby generating a list of similar trees; generating a set of similar trees based on the list of similar trees; applying the contrastive learning algorithm to the set of similar trees to obtain a deep neural network; and mapping, using the deep neural network, each tree in the list of similar trees to a corresponding vector representation having a predetermined length.

In some embodiments, the non-transitory computer-readable medium further has stored thereon a sequence of instructions for causing the one or more processors to perform: receiving an anchor sequence (x), a number of replacements (1, 2, . . . , N), a maximum subtree height (H) and a subtree replacement lookup dictionary (L); parsing the anchor sequence (x) into a tree representation (xₜᵣₑₑ); randomly selecting a random choice (n) from the number of replacements (1, 2, . . . N); and from 1 to the random choice (n): randomly selecting a subtree (t) in the tree representation (xₜᵣₑₑ) having a height less than the maximum subtree height (H), selecting a replacement subtree (r) from the subtree replacement lookup dictionary (L), and replacing the subtree (t) from the tree representation (xₜᵣₑₑ) with the replacement subtree (r) to generate an updated tree representation (updated xₜᵣₑₑ). In an example implementation, the search algorithm is a Bayesian optimization search algorithm.

### BRIEF DESCRIPTION OF THE DRAWINGS

The features and advantages of the example embodiments of the invention presented herein will become more apparent from the detailed description set forth below when taken in conjunction with the following drawings.

FIG. 1 illustrates an example contrastive embedding system for performing contrastive embedding of a structured space for Bayesian optimization in accordance with an example embodiment.

FIG. 2 is a schematic illustration of contrastive learning for a structured input space according to an example embodiment.

FIG. 3 depicts a contrastive embedding procedure for performing contrastive embedding of a structured space, according to an example embodiment.

FIG. 4 depicts a subtree replacement procedure for generating a list of similar trees, according to an example embodiment.

FIG. 5 depicts a contrastive embedding procedure for performing contrastive embedding of a structured space, according to an example embodiment.

### DETAILED DESCRIPTION

The present disclosure is based on Tingey et al., “Contrastive Embedding of Structured Space for Bayesian Optimisation”, 5th Workshop on Meta-Learning at NeurIPS 2021 (Dec. 10, 2021), which is incorporated herein by reference as if fully set forth in this disclosure.

Generally, the embodiments described herein provide an alternative representation learning mechanism, contrastive learning, to learn a generalized representations of data in a self-supervised manner. Unlike a Variational Autoencoder (VAE), contrastive learning learns a representation of the input data by explicitly modelling the similarity and dissimilarity between datapoints. The contrastive learning procedure attempts to map similar datapoints close together in the embedding and dissimilar datapoints further apart.

Further aspects of the embodiments take advantage of an improved embedding space generated using contrastive learning and the similarities between structured datapoints to conduct optimization. This allows for greater control over the distance relationships within the embedding space and allows domain-specific knowledge to be more easily incorporated to help a subsequent BO optimization ignore known unimportant variance in the data.

Yet further aspects of the embodiments use parse trees of a context-free grammar to describe the structured data to enable a simple subtree replacement strategy to generate similar datapoints within an input space with which to train an embedding using contrastive learning.

The technical problem will now be further described in detail by first describing the structured input spaces on which the embodiments described herein can operate. In an example implementation, χ represents an input space that is described by a structure of a context-free grammar (CFG). In general, a CFG is defined by a 4-tuple G=(V, E, R, S), where V is a finite set of non-terminal symbols, Σ is a finite set of terminal symbols, R is a finite set of production rules, and S is a distinct non-terminal start symbol. Each production rule in R describes a mapping α→β, for α∈V and β (V∪Σ)*, with * denoting a Kleene closure, taking a single non-terminal symbol to a sequence of non-terminal and/or terminal symbols.

The application of a production rule R to a non-terminal symbol defines a tree where the symbols of β become child nodes for the parent non-terminal of a. Given this, the complete grammar G encompasses a set of all possible trees that can be formed beginning from the start symbol root node S and recursively applying one or more production rules R to non-terminal nodes until all leaf nodes are terminal symbols in Z. The left-to-right traversal of the leaf nodes in a tree produces a corresponding string sequence of terminal symbols; across G the complete set of these sequences defines the language of the grammar, which are used as the structured input space (χ). Conversely, every string sequence x∈X can be parsed by the rules of the grammar to a corresponding parse tree representation xₜᵣₑₑ.

Within input space (χ), one technical challenge involves optimizing an objective function ƒ: X [symbol] [symbol] . The function ƒ is typically an expensive-to-evaluate black-box that has no derivative information and no analytic form. Hence, it is desirable to conduct the optimization procedure in a sample-efficient manor by evaluating ƒ as few times as possible. Instead of performing the optimization directly in the discrete high-dimensional space of input space (χ), latent space optimization (LSO) proposes to instead learn a mapping g:χ [symbol] Z to a continuous low-dimensional embedding space Z within which the optimization can be conducted. The mapping g takes the discrete datapoints x∈χ to continuous ones z∈ [symbol] . To enable optimization, a latent objective model m: [symbol] is constructed in Z such that it approximates the objective function ƒ (χ)≈m(g(x)), Δz∈X.

Previously, the mapping g has typically been chosen to be the encoder of a VAE trained on a sample of data from χ. Furthermore, m is commonly chosen to be a probabilistic model such as a Gaussian process allowing for the application of BO to perform sample-efficient optimization.

In some embodiments, an alternative mapping g is learned using contrastive learning.

### Contrastive Learning

A generalized contrastive learning framework is now described in terms of the following components: a key, a query, a similarity distribution, an encoder, a projection head, and a contrastive loss.

Query, Key: A query and a key refer to a pair (q, k) of either positive (similar) or negative (dissimilar) views of an input sample x∈X. As used herein, the term input sample x is used interchangeably with the term input data x.

Similarity Distribution: A similarity distribution p⁺(q, k⁺) is a distribution over a pair of input samples that describes the notion of similarity. A key is considered positive k⁺ for a query q if it is sampled from the similarity distribution and is considered negative k⁻ if it is sampled from the dissimilarity distribution p⁻(q, k⁻). Dissimilarity is defined by any pair not sampled from the similarity distribution.

Encoder: A neural network (of any architecture) that maps both views (q, k) of x to an embedding vector z∈Z. In the context of this work, once trained, the encoder acts as the mapping g from the input space to the embedding [symbol] for use in LSO.

Projection Head: A small dense neural network that maps all embeddings z∈ [symbol] to a space where the contrastive loss is applied v∈ [symbol] . The inclusion of a projection head separates learning a good embedding representation from learning an effective embedding to maximizing the similarity between points.

Contrastive Loss: A loss function that takes as input a set of embedded pairs in [symbol] {(v, v⁺), . . . , (v, v⁻)}. By calculating a measure of similarity between the embeddings and maximizing the similarity of positive pairs, and minimizing the similarity of negative pairs, the contrastive loss can learn a representation of the inputs.

### Contrastive Embedding of Structured Space

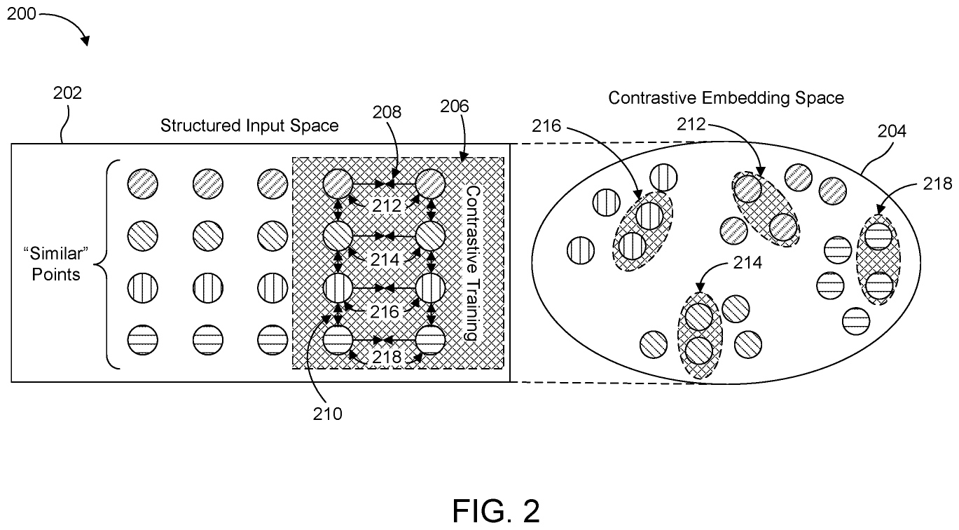

In some embodiments, a continuous low-dimensional embedding of the structured input space (χ) is learned using contrastive learning. FIG. 2 is a schematic illustration of contrastive learning for a structured input space according to an example embodiment. A structured input space 202 is shown on the left, while a learned contrastive embedding 204 is shown on the right. The structural similarity of points in the input space (indicated by the hatch-marked circles) is used to embed similar points close together in the embedding and dissimilar points further apart. A contrastive training subset 206 is a subset of the structured input space 202 used for training, with the arrows indicating how contrastive learning pulls similar points together (as depicted by the arrows pointing to each other, e.g., 208) and pushes dissimilar points apart (as depicted by the arrows pointing away, e.g., 210).

In an example embodiment, the similarity distribution p+(q, k+) in the structured input space is defined. In turn, the similarity distribution is used generate positive pairs (q, k) for use during training, as illustrated by positive pairs 212, 214, 216 and 218 in FIG. 2.

### Data Augmentation by Subtree Replacement

One aspect of the embodiments is to define similarity within input space (χ) based on the underlying structure as imposed by a context-free-grammar. Structurally similar parse tree representations in input space (χ) are considered similar. Given a sample x, by making changes to its parse tree representation xₜᵣₑₑ, a similar (positive) sample is generated. These changes are made using a subtree replacement strategy as described in more detail herein.

Given an input sample of data from input space (χ), a subtree replacement lookup dictionary L is generated (also referred to as a generated subtree replacement lookup dictionary L). For every input sample of data x of input space (χ), a corresponding parse tree representation xₜᵣₑₑ is generated and iterated over all subtrees, adding any input sample of data x not currently found to sets of subtrees in the generated subtree replacement lookup dictionary L with a key given by a combination of a root node non-terminal symbol of a corresponding subtree and a height of the root node non-terminal symbol.

Given the generated subtree replacement lookup dictionary L, along with a maximum subtree replacement height H, and the maximum number of subtrees to replace N, a subtree replacement procedure is performed.

For an input (anchor) sequence x, subtrees up to height H are randomly selected from a parse tree representation of sequence x and replaced using a randomly chosen subtree from generated subtree replacement lookup dictionary L with the same root symbol. This replacement is repeated up to N times.

In some embodiments, the replacement procedure is wrapped in a function to verify the output sequence. In certain input spaces, not all the string sequences will correspond to valid datapoints. For example, in a space containing strings of symbols representing a three-dimensional structure of a chemical (e.g., obtained from, for example, Simplified Molecular Input Line Entry System or SMILES), it may be the case that not all the string sequences correspond to valid datapoints, e.g., molecules. If an output sequence is invalid, the replacement procedure is repeated up to a predetermined number of times (e.g., 50 times) until a valid output is found. If all attempts are exhausted, in some embodiments, the sequence is discarded.

Due to the branching tree structure of the input data, in some embodiments, a number of smaller subtree replacements that are made is greater than a number of larger subtree replacements. A smaller subtree replacement changes a small portion of the original tree and a larger subtree replacement changes a larger portion of the original tree. It should be understood that the terms smaller tree and larger subtree are relative. For example, if an original arithmetic sequence is 1/sin(2−x), a change that replaces x by 2x, resulting in 1/sin(2−2x) is a smaller replacement compared to a larger change that replaces “sin(2−x)” by x, resulting in 1/x. It should be understand that the above provides an intuitive explanation why trees with smaller changes are embedded closer to each other compared to tree with larger changes. Consequently, small changes in the parse tree are more likely to occur than larger ones. When applied in contrastive learning, advantageously this encourages very similar trees to be closer in the latent space as they occur as positive pairs more often, while trees with more significant differences are encouraged to be further away as they occur less often.

Unlike the common contrastive learning approach of generating two augmented versions from the same input to use as a positive pair during training, example aspects of the embodiments described herein use each input sample of data x from input space (χ) as one half of each positive pair q and a single augmented version \tilde{x} as the other k. Advantageously, this technique produces an improved contrastive embedding. Furthermore, due to the computational bottleneck of parsing the sequences to their corresponding parse tree representations, positive pairs are not generated on the fly, but instead a number of repeats of the input data are calculated before training.

### Contrastive Learning of Embedding

How contrastive learning is implemented in accordance with an example embodiment, including a choice of an encoder, a projection head, and a contrastive loss function are now described.

In some embodiments, input to an encoder is encoded as a series of 1-hot vectors representing a sequence of production rules R found by performing a pre-order traversal on branches of a corresponding parse tree going from left-to-right. Each 1-hot is an indicator vector with each dimension corresponding to a singular rule within the grammar.

For the contrastive loss, in an example implementation, an NT-Xent (a normalized temperature-scaled cross-entropy loss) from SimCLR (a Simple Framework for Contrastive Learning of Visual Representations). Instead of explicitly sampling negative example, instead all other pairs of samples within each minibatch during training are treated as negative examples. As a notion of similarity the loss uses the cosine similarity: sim(u, v)=u^{T}v/∥u∥∥v∥, where T indicates a vector transpose and ∥ . . . ∥ refers to a vector norm (i.e., a measure of the magnitude of a vector). The full loss implementation for a positive pair of examples (i,j) is then defined according to the following equation (1):

$$ℒ = - log \frac{exp ( sim ( {z}_{i} , {z}_{j} ) / τ )}{{\sum }_{k = 1}^{2 N} exp ( sim ( {z}_{i} , {z}_{k} ) / τ )} \qquad ( 1 )$$

where τ indicates a temperature parameter and N is the size of the minibatch.

Aspects of the embodiments described herein can be applied to computer vision tasks, chemical design tasks, user experience (UX) design tasks, product configuration optimization tasks, audio domain search tasks, graph-structured data processing tasks, and the like.

Advantageously, an embedding generated using contrastive learning and a notion of similarity between structured datapoints can lead to an improved embedding space to conduct optimization within. This allows for greater control over the distance relationships within the embedding and allows domain-specific knowledge to be easily incorporated to help the subsequent Bayesian optimization (BO) ignore known unimportant variance in the data.

Aspects of the embodiments described herein also use the fact that such structured data can be described by parse trees of a context-free grammar. This allows for a simple subtree replacement strategy to be used to generate similar points within the input space with which to train an embedding using contrastive learning. Contrastive learning is used to learn a low-dimensional, continuous embedding for structured data defined by a context-free grammar. In addition, a subtree replacement strategy is used to generate structurally similar pairs for contrastive learning. The contrastive learning places structurally similar points closer to each other within the embedding. Notably aspects of the present invention are more resilient to embedding data correctly and performs better than a VAE, particularly in certain BO scenarios.

In one aspect of the embodiments, a “score” (e.g., a value) is assigned to each datapoint. In turn, a search for each datapoint that optimizes the score in a short amount of time is performed. In an example implementation, the search is performed by using a search algorithm that finds a datapoint in a representation that has an optimal score (or value) for the search problem of interest. Advantageously, a contrastive representation is used to essentially transform the data such that the datapoint that optimizes the score is more efficiently determined.

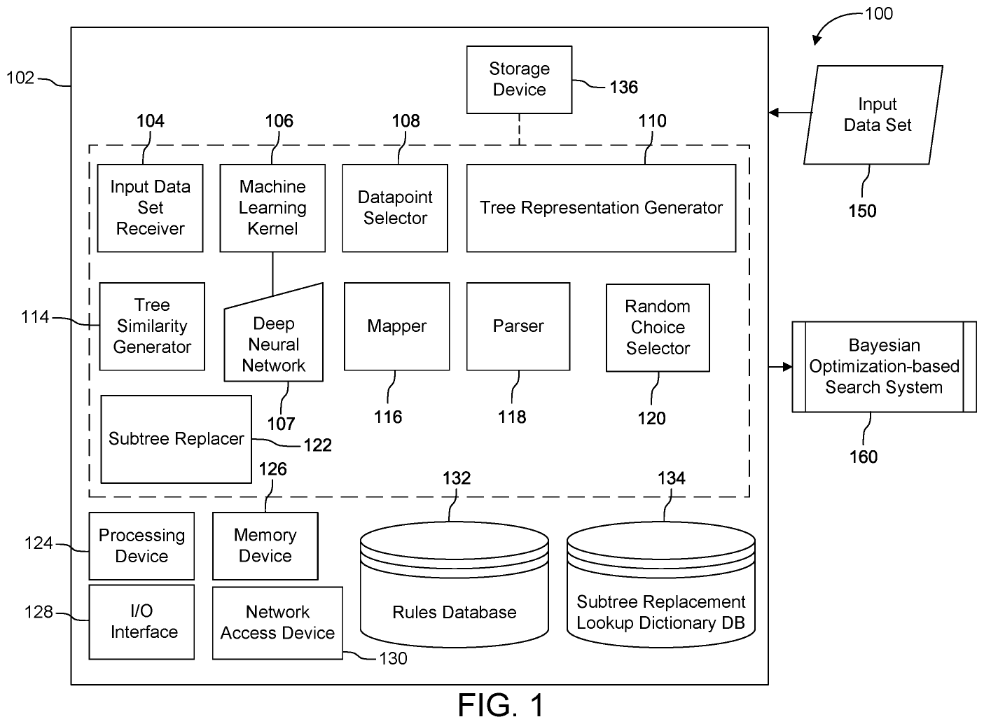

FIG. 1 illustrates an example contrastive embedding system 102 for performing contrastive embedding of a structured space for Bayesian optimization in accordance with an example embodiment.

In the example of FIG. 1, the contrastive embedding system 102 includes an input data set receiver 104, a machine learning kernel 106, a datapoint selector 108, a tree representation generator 110, a tree similarity generator 114, a mapper 116, a parser 118, a random choice selector 120, a subtree replacer 122, a processing device 124, a memory device 126, a storage device 126, an input/output (I/O) interface 128, a network access device 130, a rules database 132, and a subtree replacement lookup dictionary database 134.

In an example embodiment, the processing device 124 also includes one or more central processing units (CPUs). In another example embodiment, the processing device 124 includes one or more graphic processing units (GPUs). In other embodiments, the processing device 124 may additionally or alternatively include one or more digital signal processors, field-programmable gate arrays, or other electronic circuits as needed.

The memory device 126 (which as explained below is a non-transitory computer-readable medium), coupled to a bus, operates to store data and instructions to be executed by processing device 124. The instructions, when executed by processing device 124 can operate as input data set receiver 104, machine learning kernel 106, datapoint selector 108, tree representation generator 110, tree similarity generator 114, mapper 116, parser 118, random choice selector 120, and subtree replacer 122. The memory device 126 can be, for example, a random-access memory (RAM) or other dynamic storage device. The memory device 126 also may be used for storing temporary variables (e.g., parameters) or other intermediate information during execution of instructions to be executed by processing device 124.

The storage device 136 may be a nonvolatile storage device for storing data and/or instructions for use by processing device 124. The storage device 136 may be implemented, for example, with a magnetic disk drive or an optical disk drive. In some embodiments, the storage device 136 is configured for loading contents of the storage device 136 into the memory device 126.

I/O interface 128 includes one or more components which a user of the contrastive embedding system 102 can interact. The I/O interface 128 can include, for example, a touch screen, a display device, a mouse, a keyboard, a webcam, a microphone, speakers, a headphone, haptic feedback devices, or other like components.

Examples of the network access device 130 include one or more wired network interfaces and wireless network interfaces. Examples of such wireless network interfaces of a network access device 130 include wireless wide area network (WWAN) interfaces (including cellular networks) and wireless local area network (WLANs) interfaces. In other implementations, other types of wireless interfaces can be used for the network access device 130.

The network access device 130 operates to communicate with components outside contrastive embedding system 102 over various networks. Such components outside the contrastive embedding system 102 can be, for example, one or more sources of input data 150 and a Bayesian optimization-based search system 160.

The rules database 132 and subtree replacement lookup dictionary database 134 are, in some embodiments, located on a system independent of, but communicatively coupled to, contrastive embedding system 102.

Generally, memory device 126 and/or storage device 136 operate to store instructions, which when executed by one or more processing devices 124, cause the one or more processing devices 124 to perform the methods described herein.

In some embodiments, memory device 126 and/or storage device 136 operate to store instructions, which when executed by one or more processing devices 124, cause the one or more processing devices 124 to operate as any one or a combination of input data set receiver 104, machine learning kernel 106, datapoint selector 108, tree representation generator 110, tree similarity generator 114, mapper 116, parser 118, random choice selector 120, and subtree replacer 122.

In an example embodiment input sample receiver 104 operates to receive an input sample set of data (x) corresponding to an input space (χ). In an example implementation, input sample set of data (x) can be received by contrastive embedding system 102 from input data set 150. Rules database 132 stores rules defining similarities in embeddings of sample sets of data. Machine learning kernel 106 operates to obtain a set of rules (R) from rules database 132, particularly defining similarities in an embedding of the sample set of data (x). Machine learning kernel 106 further operates to obtain, from the rules database 132, a set of rules (R) defining similarities in an embedding of the sample set of data (x) and train deep neural network 107 using a contrastive learning algorithm to learn a representation of the sample set of data (x) by modelling a plurality of points in the sample set of data based on the set of rules.

Contrastive embedding system 102 is further configured to transmit, for example using network access device 130, the representation of the sample set of data (x) to a search system to enable the search system to apply a search algorithm on the representation of the sample set of data (x). In an example embodiment the search algorithm executed by the search system is a Bayesian optimization-based search system 160.

In some embodiments, subtree replacement lookup dictionary database 134 is configured to store one or more subtree replacement lookup dictionaries. Tree representation generator 110 is configured to: obtain a subtree replacement lookup dictionary (L) from the subtree replacement lookup dictionary database and generate, for every sample of the input sample set of data (x), a tree representation (xₜᵣₑₑ), thereby creating a set of tree representations. For each tree in the set of tree representations, the tree representation generator 110 generates a list of trees that are similar, thereby generating a list of similar trees, and generates a set of similar trees based on the list of similar trees. In turn, the machine learning kernel 106 operates to apply the contrastive learning algorithm to the set of similar trees to obtain a deep neural network 107. A mapper 116 is configured to map, using the deep neural network, each tree in the list of similar trees to a corresponding vector representation having a predetermined length.

In some embodiments, the input data set receiver 104 receives an anchor sequence (x), a number of replacements (1, 2, . . . , N), a maximum subtree height (H) and a subtree replacement lookup dictionary (L). Parser 118, in turn, operates to parse the anchor sequence (x) into a tree representation (xₜᵣₑₑ).

Random choice selector 120 operates to randomly select a random choice (n) from the number of replacements (1, 2, . . . , N). In turn, from 1 to the random choice (n), subtree replacer 122 operates to randomly select a subtree (t) in the tree representation (xₜᵣₑₑ) having a height less than the maximum subtree height (H), select a replacement subtree (r) from the subtree replacement lookup dictionary (L), and replace the subtree (t) from the tree representation (xₜᵣₑₑ) with the replacement subtree (r) to generate an updated tree representation (xₜᵣₑₑ (updated)).

In some embodiments, the search algorithm used by the search system is a Bayesian optimization-based search system 160.

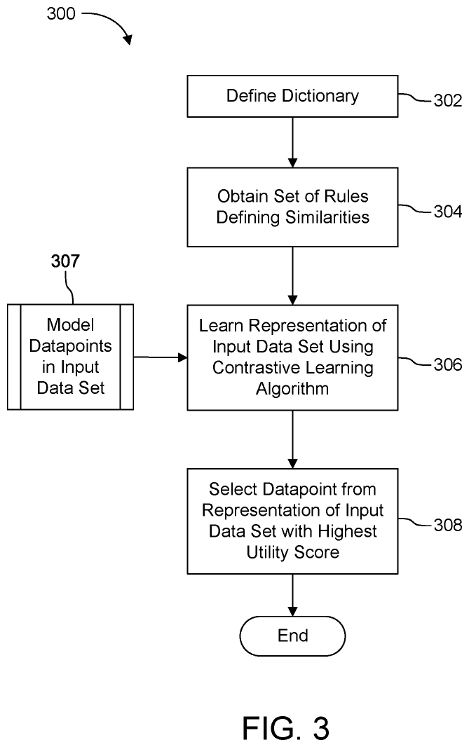

FIG. 3 depicts a contrastive embedding procedure 300 for performing contrastive embedding of a structured space, according to an example embodiment. A dictionary defining operation 302 performs defining a dictionary. In turn, a rule receiving operation 304 performs obtaining a set of rules (R) defining similarities in an embedding of an input sample set of data (x) (sometimes referred to simply as an input data set). A learning operation 306 performs learning to learn a representation of the input sample set of data (x) using a contrastive learning algorithm. In some embodiments, learning operation 306 includes a modeling operation 307 that performs modelling of a plurality of datapoints in an input sample set of data (x) based on the set of rules (R). The representation of the input set of data is then transmitted to a search system that executes a search algorithm. In an example embodiment, a selection operation 308, in turn, operates to perform selecting from the representation of the input sample set of data a datapoint having a score that is higher than a score associated with other datapoints in the representation of the input sample set of data (x), using a search algorithm (e.g., a Bayesian optimization algorithm).

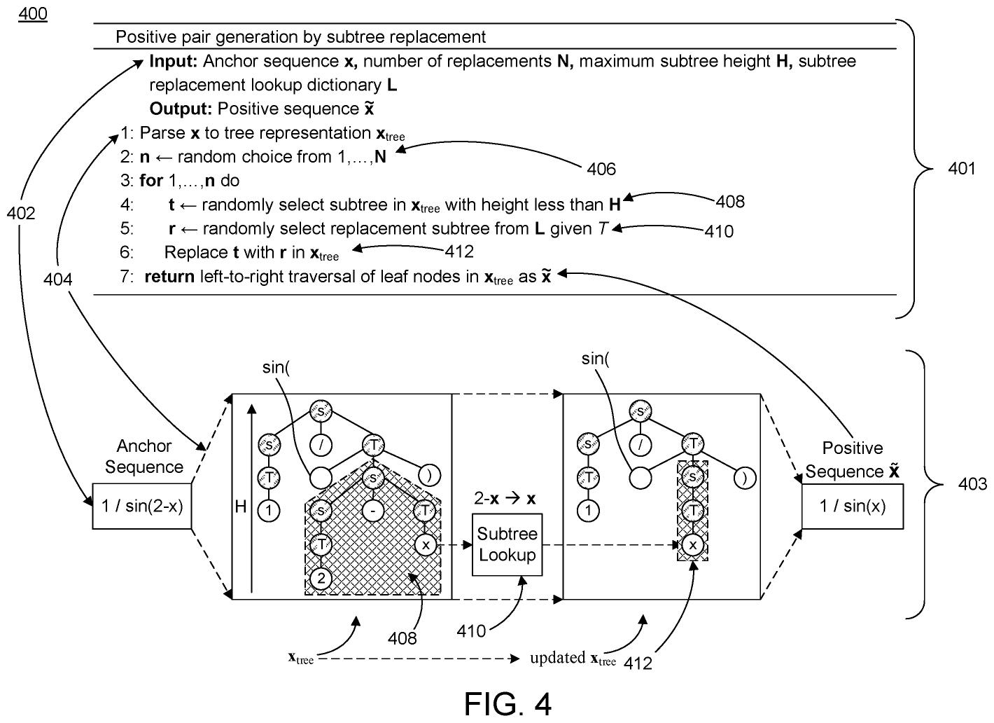

FIG. 4 depicts a subtree replacement procedure 400 for generating a list of similar trees according to an example embodiment. Subtree replacement procedure 400 is illustrated by using both pseudocode 401 and a data-flow diagram 403. Generating a list of similar trees generates a set of similar trees. For each tree in an input sample set of data (x), a list of similar trees is generated. In turn, all the lists of similar trees are grouped together to form a set of similar trees. In FIG. 4, “S” and “T” are variables in context-free grammar. An anchor sequence is described as an arithmetic expression “1/sin(2−x)”, where the “x” is a variable. It should be understood that variable “x” in the arithmetic expression is different from a “sequence x” as used in the pseudo-code in FIG. 4. A receiving operation 402 performs receiving an anchor sequence (x), a number of replacements (1, 2, . . . , N), a maximum subtree height (H), and a subtree replacement lookup dictionary (L). A parsing operation 404 performs parsing the anchor sequence (x) into a tree representation (xₜᵣₑₑ). The parsing operation 404 thus receives the anchor sequence (x) and generates, based on the anchor sequence (x), a tree representation (xₜᵣₑₑ). Stated differently, parsing operation 404 parses the anchor sequence (x) into a tree representation (xₜᵣₑₑ). Parsing operation 404 is illustrated as step 1 in the pseudocode 401.

In turn, a choice selection operation 406 performs randomly selecting a random choice (n) from the number of replacements (1, 2, . . . , N). The choice selection operation 406 is illustrated as step 2 in pseudocode 401. A subtree replacement operation 408, which is described in more detail below, will then be performed n-times to perform a total number of n replacements, where the random choice (n). Choice selection operation 406 is not shown in the data-flow diagram 403 as data-flow diagram 403 illustrates one iteration of a subtree replacement. Steps 3, 4, 5, 6, 7 will be iterated n-times. The subtree selection operation 408 performs randomly selecting a subtree (t) in the tree representation (xₜᵣₑₑ) having a height less than the maximum subtree height (H). Subtree selection operation 408 is illustrated as step 4 in pseudocode 401.

A first subtree replacement operation 410 (“Subtree Lookup”) performs selecting a replacement subtree (r) from the subtree replacement lookup dictionary (L). First subtree replacement operation 410 is illustrated as step 5 in the pseudocode 401.

A second replacement operation 412 performs replacing the subtree (t) from the tree representation (xₜᵣₑₑ) with the replacement subtree (r). The result is an updated tree representation (updated xₜᵣₑₑ). Second replacement operation 412 is illustrated as step 6 in the pseudocode 401.

In an example implementation, the subtree lookup 2−x→x is the first subtree replacement operation 410. It should be understood that the subtree lookup 2−x→x as used in FIG. 4 is one instance of the subtree replacement lookup dictionary “L”. There can be more instances like this in the subtree replacement lookup dictionary “L” resulting in a new tree representation.

The new tree representation can then be used to train an embedding using a contrastive embedding procedure.

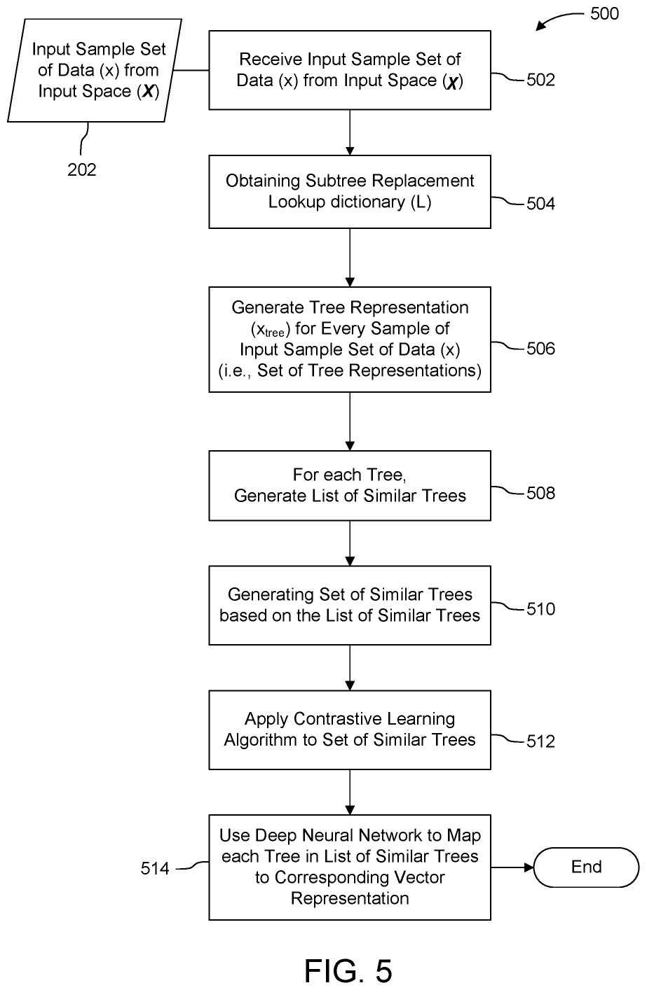

FIG. 5 depicts a contrastive embedding procedure 500 for performing contrastive embedding of a structured space, according to an example embodiment. A receiving operation 502 performs receiving an input sample set of data (x) from an input space (χ). In turn, a subtree obtaining operation 504 performs obtaining a subtree replacement lookup dictionary (L). The subtree replacement lookup dictionary (L) can be obtained, for example, from domain knowledge. A tree representation generating operation 506 performs generating, for every sample of the input sample set of data (x), a tree representation (xₜᵣₑₑ), thereby creating a set of tree representations. A similar tree list generating operation 508 performs, for each tree in the set of tree representations, generating a list of similar trees. In an example implementation the list of similar trees is generated according to the subtree replacement procedure 400 described above in connection with FIG. 4. A similar tree generating operation 510 performs generating a set of similar trees based on the list of similar trees. A contrastive learning operation 512 performs applying a contrastive learning algorithm to the set of similar trees to obtain a deep neural network. In turn, a mapping operation 514 performs mapping, using the deep neural network, each tree in the list of similar trees to a corresponding vector representation with a predetermined length. In an example implementation, the length of the corresponding vector is 25. It should be understood that in some embodiments, the length of the corresponding vector can be another length.

### Technical Use Cases for Contrastive Embedding of Structured Space for Bayesian Optimization

The example embodiments described herein solve the ML problem about searching for the optimum of an expensive objective function defined over a structured space. This ML problem can be mapped to many technical use cases, including:

Chemical Design. Medical drug development requires searching for the chemical molecule that has the desired properties such as having the maximum treatment effects while having minimum side effects. A chemical molecule is represented as atoms held together by chemical bonds. The search problem is to look for the molecule that has the most desired property from a database of potential molecules. It is an expensive search problem because determining the properties of a molecule requires a wet lab experiment, which costs lots of time and money. Aspects of the embodiments described herein can help speed up the search process by suggesting the promising molecules to evaluate based on the results obtained so far.

In an example use case drug properties of molecules are optimized with the goal being to maximize the penalized water-octanol partition coefficient (log P) of molecules, an indicator for its drug-likeness. The task is framed as minimizing the −log P. Simplified Molecular-Input Line-Entry System (SMILES) is a specification that describes the structure of molecules using strings and can be described using a context-free grammar. As training data, a predetermined number of SMILES strings (e.g., 25,000 SMILES strings) are taken from a Quantum Machines 9 (QM9) dataset of molecules with fewer than a predetermined number of heavy atoms (e.g., 9). Some example SMILES strings include CC1=CN(C)C(=O)C1O and N=C1OC2NC1(O)C2.

An iteration over the 25,000 anchor samples is performed a predetermined number of times (e.g., 25 times) to generate the static training set for use during contrastive training, with a maximum subtree replacement height H of, e.g., 12, and the maximum number of subtrees to replace N of, e.g., 2. For a VAE model, train is performed on a predetermined number of samples, e.g., 25,000 samples.

UX Design. UX design can also be viewed as an expensive search problem. When designing an UX, one faces multi-level design problems from the user interaction flow to style and feeling individual UI components. Each of these design problems can be phrased as searching for a specific design from all the possibilities that maximizes user's satisfaction. This is an expensive search problem because (i) the number of possibilities is often huge as it is the combinatorics of individual design choices such as whether to include a button and the style and feel of the button. (ii) it is costly to evaluate a UX design as it involves either some user interviews or collecting user statistics after deployment. The example embodiments described herein help speed up this search problem by suggesting the next one or few UX designs to evaluate based on the feedback collected so far (by evaluating a set of UX designs). For example, when searching for the best layout of a home page, the score can be based on user enjoyment (or various proxies of that) and the homepage that optimizes this score can be determined.

Product configuration optimization. Similar to UX design, when developing a product, there may be many configurations about our product to decide. For example, there may be a need to decide which algorithm to use with a specific choice of its parameters. The choices of algorithms often might be different for different user groups and countries and different types of content. The overall configuration is the combinatorics of these individual choices, which is a huge space. The evaluation of a product configuration is expensive because it often needs to be evaluated based on real user feedback, which means that the individual components associated with each choice need to be developed and deployed to production. The example embodiments described herein help speed up the problem of searching for the best product configuration by suggesting the promising next configuration to try out based on the feedback collected so far.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terminology used herein is for the purpose of describing particular examples only and is not intended to be limiting. As used herein, the singular forms “a”, “an” and “the” are intended to include the plural forms as well, unless the context clearly indicates otherwise.

In the interest of clarity, not all features of an actual implementation are described in this specification. It will of course be appreciated that in the development of any such actual example, numerous implementation-specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In addition, not all of the components are required to practice the invention, and variations in the arrangement and type of the components may be made without departing from the spirit or scope of the invention. As used herein, the term “component” is applied to describe a specific structure for performing specific associated functions, such as a special purpose computer as programmed to perform algorithms (e.g., processes) disclosed herein. The component can take any of a variety of structural forms, including: instructions executable to perform algorithms to achieve a desired result, one or more processors (e.g., virtual or physical processors) executing instructions to perform algorithms to achieve a desired result, or one or more devices operating to perform algorithms to achieve a desired result.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above-described example embodiments but should be defined only in accordance with the following claims and their equivalents.

In addition, it should be understood that the figures are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method for performing contrastive embedding of a structured space, comprising the steps of:
receiving an input sample set of data (x) corresponding to an input space (χ);
obtaining a set of rules (R) defining similarities in an embedding of the sample set of data (x);
training a deep neural network using a contrastive learning algorithm to learn a representation of the sample set of data (x) by modelling a plurality of points in the sample set of data based on the set of rules; and
supplying the representation of the sample set of data (x) to a search system to apply a search algorithm on the representation of the sample set of data(x).

2. The method according to claim 1, further comprising the step of:
selecting from the representation of the sample set of data (x) a datapoint having a score that is higher than a score associated with other datapoints in the representation of the sample set of data (x), using a search algorithm.

3. The method according to claim 1, further comprising the steps of:
obtaining a subtree replacement lookup dictionary (L);
generating, for every sample of the input sample set of data (x), a tree representation (xₜᵣₑₑ), thereby creating a set of tree representations;
for each tree in the set of tree representations, generating a list of trees that are similar, thereby generating a list of similar trees;
generating a set of similar trees based on the list of similar trees;
applying the contrastive learning algorithm to the set of similar trees to obtain a deep neural network; and
mapping, using the deep neural network, each tree in the list of similar trees to a corresponding vector representation having a predetermined length.

4. The method according to claim 1, wherein generating the list of similar trees is performed by:
receiving an anchor sequence (x), a number of replacements (1, 2, . . . , N), a maximum subtree height (H) and a subtree replacement lookup dictionary (L);
parsing the anchor sequence (x) into a tree representation (xₜᵣₑₑ);
randomly selecting a random choice (n) from the number of replacements (1, 2, . . . , N); and
from 1 to the random choice (n):
randomly selecting a subtree (t) in the tree representation (xₜᵣₑₑ) having a height less than the maximum subtree height (H),
selecting a replacement subtree (r) from the subtree replacement lookup dictionary (L), and
replacing the subtree (t) from the tree representation (xₜᵣₑₑ) with the replacement subtree (r) to generate an updated tree representation (updated xₜᵣₑₑ).

5. The method according to claim 1, wherein the search algorithm is a Bayesian optimization algorithm.

6. A system for performing contrastive embedding of a structured space, comprising:
a rules database configured to store rules defining similarities in embeddings of the sample sets of data;
an input sample receiver configured to receive an input sample set of data (x) corresponding to an input space (χ);
a machine learning kernel configured to:
obtain, from the rules database, a set of rules (R) defining similarities in an embedding of the sample set of data (x), and
train a deep neural network using a contrastive learning algorithm to learn a representation of the sample set of data (x) by modelling a plurality of points in the sample set of data based on the set of rules; and
a network access device configured to supply the representation of the sample set of data (x) to a search system to enable the search system to apply a search algorithm on the representation of the sample set of data (x).

7. The system of claim 6, further comprising:
a search system configured to select from the representation of the sample set of data (x) a datapoint having a score that is higher than a score associated with other datapoints in the representation of the sample set of data (x), using the search algorithm.

8. The system of claim 6, further comprising:
a subtree replacement lookup dictionary database configured to store one or more subtree replacement lookup dictionaries;
a tree representation generator configured to:
obtain a subtree replacement lookup dictionary (L) from the subtree replacement lookup dictionary database and generate, for every sample of the input sample set of data (x), a tree representation (xₜᵣₑₑ), thereby creating a set of tree representations,
for each tree in the set of tree representations, generate a list of trees that are similar, thereby generating a list of similar trees, and
generate a set of similar trees based on the list of similar trees; and
the machine learning kernel configured to apply the contrastive learning algorithm to the set of similar trees to obtain a deep neural network; and
a mapper configured to map, using the deep neural network, each tree in the list of similar trees to a corresponding vector representation having a predetermined length.

9. The system according to claim 6, further comprising:
the input data set receiver 104 further configured to receive an anchor sequence (x), a number of replacements (1, 2, . . . , N), a maximum subtree height (H) and a subtree replacement lookup dictionary (L);
a parser configured to parse the anchor sequence (x) into a tree representation (xₜᵣₑₑ);
a random choice selector operable to randomly select a random choice (n) from the number of replacements (1, 2, . . . , N); and
a tree representation generator 110 configured to:
from 1 to the random choice (n):
randomly select a subtree (t) in the tree representation (xₜᵣₑₑ) having a height less than the maximum subtree height (H),
select a replacement subtree (r) from the subtree replacement lookup dictionary (L), and
replace the subtree (t) from the tree representation (xₜᵣₑₑ) with the replacement subtree (r) to generate an updated tree representation (updated xₜᵣₑₑ).

10. The system according to claim 7, wherein the search algorithm is a Bayesian optimization algorithm.

11. A non-transitory computer-readable medium having stored thereon one or more sequences of instructions for causing one or more processors to perform:
receiving an input sample set of data (x) corresponding to an input space (χ);
obtaining a set of rules (R) defining similarities in an embedding of the sample set of data (x);
training a deep neural network using a contrastive learning algorithm to learn a representation of the sample set of data (x) by modelling a plurality of points in the sample set of data based on the set of rules; and
supplying the representation of the sample set of data (x) to a search system to apply a search algorithm on the representation of the sample set of data(x).

12. The non-transitory computer-readable medium of claim 11, further having stored thereon a sequence of instructions for causing the one or more processors to perform:
selecting from the representation of the sample set of data (x) a datapoint having a score that is higher than a score associated with other datapoints in the representation of the sample set of data (x), using a search algorithm.

13. The non-transitory computer-readable medium of claim 11, further having stored thereon a sequence of instructions for causing the one or more processors to perform:
obtaining a subtree replacement lookup dictionary (L);
generating, for every sample of the input sample set of data (x), a tree representation (xₜᵣₑₑ), thereby creating a set of tree representations;
for each tree in the set of tree representations, generating a list of trees that are similar, thereby generating a list of similar trees;
generating a set of similar trees based on the list of similar trees;
applying the contrastive learning algorithm to the set of similar trees to obtain a deep neural network; and
mapping, using the deep neural network, each tree in the list of similar trees to a corresponding vector representation having a predetermined length.

14. The non-transitory computer-readable medium of claim 10, further having stored thereon a sequence of instructions for causing the one or more processors to perform:
receiving an anchor sequence (x), a number of replacements (1, 2, . . . , N), a maximum subtree height (H) and a subtree replacement lookup dictionary (L);
parsing the anchor sequence (x) into a tree representation (xₜᵣₑₑ);
randomly selecting a random choice (n) from the number of replacements (1, 2, . . . , N); and
from 1 to the random choice (n):
randomly selecting a subtree (t) in the tree representation (xₜᵣₑₑ) having a height less than the maximum subtree height (H),
selecting a replacement subtree (r) from the subtree replacement lookup dictionary (L), and
replacing the subtree (t) from the tree representation (xₜᵣₑₑ) with the replacement subtree (r) to generate an updated tree representation (updated xₜᵣₑₑ).

15. The method according to claim 12, wherein the search algorithm is a Bayesian optimization algorithm.
